(19) United States
(12) Patent Application Publication
(10) Pub. No.: US 2012/0288354 A1
(43) Pub. Date: Nov. 15, 2012

(54) LOAD TRANSFERRING MECHANISM IN A SHEET-FEEDING SYSTEM

(75) Inventor: AARON MICHAEL MOORE, Fairport, NY (US)

(73) Assignee: XEROX CORPORATION, NORWALK, CT (US)

(21) Appl. No.: 13/105,818

(22) Filed: May 11, 2011

(51) Int. Cl. B65H 31/30; B65G 49/00

(52) U.S. Cl. 414/790.1; 414/800

(57) ABSTRACT

An apparatus for transferring load in a sheet-feeding system is described. The apparatus employs a rack, which is vertically movable between a loading position and a rack transfer position. The rack has a ribbed structure. Further, a movable cart in the apparatus can shift between a cart transfer position, an external position, and an unloading position. The cart, like the rack, is also a ribbed structure including a number of ribs. The rack ribs and the cart ribs are positioned to intercalate in the respective rack and cart transfer positions. In addition, the apparatus facilitate elevation of the cart from the floor once the load is transferred from the rack to the cart.

### TECHNICAL FIELD

The presently disclosed embodiments generally relate to methods and systems for transferring articles in a production environment. More particularly, the disclosure relates to transferring stacks of sheets in a sheet-feeding system.

### BACKGROUND

The embodiments disclosed below relate to devices in which sheets (sheet material including paper, corrugated cardboard, or the like) are processed in a stream and then stacked at the end of a process or machine. In general, these sheets accumulate on a conveyor device that descends as sheets are added to the top of the stack. When the stack is complete or the conveyer device is full, however, the load must be removed, an operation which generally requires the intervention of an operator. If no operator is available, the machine shuts down until one is available.

Consider the example of a finisher for an image forming apparatus such as a copier, a printer, or a facsimile machine. The finisher may perform any number of operations, such as predetermined punching, stapling, and the like. In high-speed, high-volume printers or copiers, print job sets must be frequently unloaded from an output stacking tray. Furthermore, such high volume reproduction machines typically are shared usage or copy center machines, receiving multiple print jobs from many different users, requiring high productivity. Thus, when a job is completed or the output stacking tray is full, the finisher shuts down until an operator attends to it, and the resulting shutdown time causes a loss of productivity.

It would be highly desirable to have a relatively simple and cost effective device that increases the productivity of a machine by minimizing the idle time, waiting for an operator to unload.

### SUMMARY

One embodiment of the present disclosure provides a load transferring apparatus including a rack, vertically movable between a loading position and a rack transfer position, having a number of rack ribs. The upper surfaces of the rack ribs define a rack surface. The apparatus also includes a movable cart having a number of cart ribs. The upper surface of the cart ribs defines a cart surface for receiving the load from the rack. The cart is configured to move between a cart transfer position, an external position, and an unloading position. The rack ribs and the cart ribs are positioned to intercalate in the respective rack and cart transfer positions.

Another embodiment discloses a method for transferring a load in an apparatus. The apparatus includes a rack, having multiple rack ribs, and a cart, having a multiple cart ribs. The rack is movable between a loading position and a rack transfer position, and the cart is movable between a cart transfer position, an external position, and an unloading position. The method includes receiving a load on the rack, the rack being in the loading position. Next, intercalating the rack ribs in between the cart ribs such that the rack and cart being in the respective rack and cart transfer positions. The intercalating includes positioning the rack at or below the level of the cart for transferring the load from the rack to the cart. Subsequently, the method includes moving the cart to an external position, and repositioning the rack to the loading position. Finally, the method includes elevating the cart vertically to the unloading position.

Another embodiment of the present disclosure provides an apparatus for transferring a stack of sheet from a sheet-feeding system. The sheet feeding system includes a rack, vertically movable between a loading position and a rack transfer position and having a plurality of rack ribs, the upper surfaces of the rack ribs define a rack surface. The apparatus includes a cart having a plurality of cart ribs, the upper surface of the cart ribs define a cart surface for receiving the stack of sheets from the rack. The cart is disposed vertically below the rack. The cart is configured to move horizontally between a cart transfer position and an external position, and vertically between the external position and an unloading position. The rack ribs and the cart ribs are positioned to intercalate in the respective rack and cart transfer positions.

### BRIEF DESCRIPTION OF THE DRAWINGS

FIG. 1 illustrates an exemplary embodiment of an apparatus for transferring load.

FIG. 2 illustrates the apparatus, having a stack of sheets, where both the rack and the cart are in their respective transfer positions.

FIG. 3 is a cross-sectional view of the rack and cart in their respective transfer positions, taken on plane Y-Z of FIG. 2.

FIG. 4 illustrates an embodiment of the apparatus having the cart being displaced horizontally to an external position.

FIG. 5 is an embodiment of the apparatus depicting the rack being repositioned to a loading position, shown in FIG. 1, while the cart is displaced horizontally.

FIG. 6 is an embodiment of the apparatus depicting the cart being elevated to a convenient height.

FIG. 7 shows the rack receiving a new stack of sheets while the previous stack is waiting for an operator to unload.

FIG. 8 illustrates the cart being repositioned within apparatus, and the rack ready for transferring the new stack to the cart.

### DETAILED DESCRIPTION

The following detailed description is made with reference to the figures. Preferred embodiments are described to illustrate the disclosure, not to limit its scope, which is defined by the claims. Those of ordinary skill in the art will recognize a variety of equivalent variations on the description that follows.

### Overview

According to aspects of the disclosure illustrated here, a machine for transferring load is described. The machine employs a rack, which is vertically movable between a loading position and a rack transfer position. The rack has a ribbed structure, such that the upper surfaces of the rack ribs define a rack surface. Further, a horizontally and vertically movable cart in the apparatus can shift between three positions—a cart transfer position, located directly under the rack; an external position, horizontally disposed away from the rack; and an unloading position, vertically raised to a convenient height for off-loading. The cart, like the rack, is also a ribbed structure including a number of ribs, the upper surface of which defines a cart surface.

The rack receives a stream of sheets that stack on the rack surface. Upon a determination that the load on the rack needs to be transferred to the cart, the rack ribs intercalate between the cart ribs. At this point, the rack and cart are in their respective rack and cart transfer positions. The machine also includes a mechanism for moving the cart from the cart transfer position to the external position and subsequently raising it to the unloading position. While the stack is ready for unloading from the cart manually or through an automatic means, the rack repositions itself to receive another load. The machine is designed to allow continuous processing of loads and for minimizing the time for which the machine is idle, waiting for an operator to perform unloading. In addition, elevating the cart to the unloading position allows convenient off-loading by an operator.

The exemplary embodiments discussed below perform certain operations on sheet media within a finisher and then stacks them for output. Various other embodiments, however, can be anticipated to address many different systems or applications in which a load of articles is transferred out of a collection area on a production machine, allowing for an unattended unload and continued operation of the machine.

As used throughout this disclosure, the terms “sheet” or “document” refer to physical sheets of paper, plastic, or other suitable substrate, whether precut or initially web fed and then cut. A “job” is normally a set of related sheets, usually a collated copy set copied from a set of original document sheets or electronic document page images, from a particular user, or otherwise related. It should be understood that the concepts set out here can be employed both in devices handling relatively small sheets, such as paper, as well as apparatus handling large sheets of material such as corrugated cardboard material.

### Exemplary Embodiments

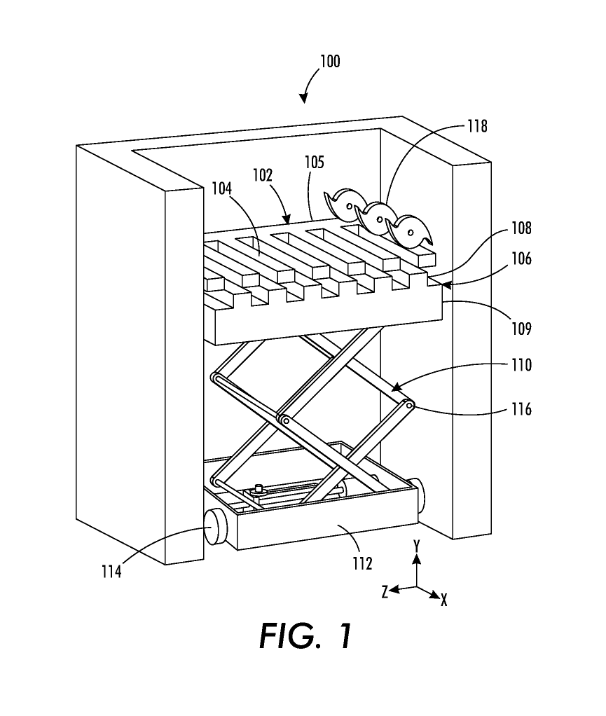

FIG. 1 illustrates an exemplary embodiment of an apparatus 100 for transferring a load. The apparatus 100 includes a rack 102 having multiple ribs 104, and a cart 106 having similar ribs 108. The apparatus 100 shown here lays out the elements performing the unloading function of a finisher.

Rack 102 is a vertically movable structure having rack ribs 104. Each rack rib 104 is an elongated member attached to and extending from a transverse member 105. Transverse member 105 runs generally in a direction parallel to the Z-axis of FIG. 1, and rack ribs 104 extend perpendicularly, in a direction parallel or along the Y-axis. The upper surface of rack 102 defines a rack surface for receiving a load. In terms of the process being performed on the finisher, rack ribs 104 lie perpendicular to the flow of sheets. The number and size of the rack ribs 104 depends primarily on the nature of the sheets being processed by the finishing apparatus, a determination well within the level of skill in the art.

Rack 102 is configured to move up and down within the apparatus 100, alternating between a loading position and a rack transfer position as described more fully below. To this end, the rack 102 may be attached to an elevating mechanism (not shown) that enables vertical movement. FIG. 1 depicts rack 102 in an elevated position, referred to as a loading position, ready to receive a load of sheets.

As used here, “loading position” is that position where the rack 102 starts receiving sheets from an image-forming device or a sheet-feeding system. In general, the loading position is an elevated position close to the top end of the apparatus 100 such that it allows a greater number of sheets to stack on top to the rack 102. The exact location of the loading position will generally be dictated by the configuration of the image-forming device. As they are fed from the image-forming device, sheets collect on the rack surface, and in many applications, the rack 102 lowers as successive sheets are added, thus converting the stream of sheets into a stack. Particular processing apparatus will vary in the number of sheets that can be stacked on rack 102, and even for a single apparatus, the number of sheets in a full load will vary based on the sheet material. In the illustrated embodiment, the apparatus 100 will accommodate 3,500 sheets of paper.

Accumulation of sheets on the rack surface will continue until the apparatus senses that a full load has been collected or a desired number of sheets has been loaded. The apparatus can employ any of the widely known sensing devices available to the art for this purpose. At that point, rack 102 moves to a rack transfer position (discussed in the following sections), located below the loading position. At rack transfer position, the stack of sheets loaded on the rack 102 can be lowered onto the cart 106.

Cart 106, like rack 102, includes multiple ribs, here in the form of cart ribs 108, whose upper surface defines a cart surface. Cart ribs 108, which are parallel to rack ribs 104, extend laterally on a rectangular platform 109. Also, cart ribs 108 are located and sized so that the set of cart ribs 108 will exactly intercalate with the set of rack ribs 104. Here, “intercalate” bears its normal meaning, “to insert between or among existing elements or layers.” Thus, as the cart ribs 108 and the rack ribs 104 approach each other, one set of ribs enters the spaces between the other set, just as the fingers of one hand can pass through the gaps between the fingers of the other hand. In this manner, cart ribs 108 and rack ribs 104 can move vertically past each other. If desired, the two sets of ribs can be halted at a single level, so that the cart ribs 108 and rack ribs 104 lie at the same level.

Each rack rib 104 and cart rib 108 may be identical in dimension, and the spacing between two consecutive rack or cart ribs may be enough to accommodate another rib for intercalation. Although FIG. 1 depicts ribs 104 and 108 as rectangular bars having a uniform cross-sectional shape, those skilled in the art will understand that ribs may assume any desired shape and size that allow intercalation between the two elements. Thus, ribs 104 and 108 can be embodied by any structure in which the individual elements can be inserted between and can pass through one another.

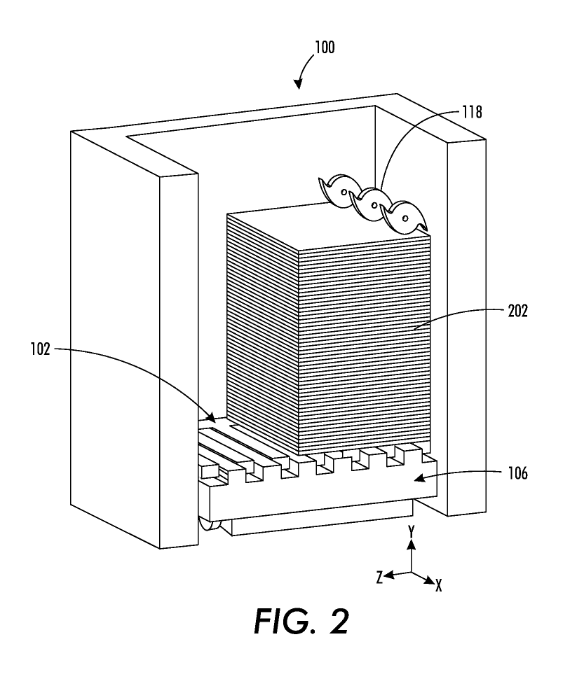

In general, the cart 106 is positioned just beneath the rack 102 such that rack ribs 104 are spaced apart from and just below cart ribs 108. As the rack 102 moves down with the load of a stack, the cart 106 also lowers. Apart from vertical movement, the cart 106 is also configured to move horizontally. The cart 106 can alternate between a cart transfer position, an external position, and an unloading position, respectively directly under the moveable rack 102, horizontally disposed away from the rack 102, and elevated vertically to a convenient height. These positions of the cart 106 are discussed in detail in the following sections in connection with FIGS. 2-7.

The base of the cart 106 is connected to a repositioning mechanism 110 that facilitates vertical and horizontal movement of the cart 106. As shown, the repositioning mechanism 110 includes a base 112 connected to a set or rollers or wheels 114 that allow horizontal movement of the cart 106, and an expandable member 116 extends from the base 112 to the cart ribs 108. The wheels 114 may be designed to roll on a track or a rail (not shown) that limits the horizontal movement of the cart, and defines a horizontal path for bracket mounted on a belt, which is energized by a motor. Such horizontally repositioning mechanism facilitates pushing the cart 106 away from the apparatus 100 in X-axis to the external position. The expandable member 116 may be a scissor-lift mechanism that unfolds the cart 106. Alternatively, base 112 may include protrusions or projects that can roll on the rails. Further, to push out or pull back cart 106, apparatus 100 may employ a to increase the height of cart 106, and the compression of the scissor-lift mechanism lowers the cart 106. In addition, the wheels 114 and the expandable member 116 may be connected to a motor that controls the displacement of the cart 106 in the horizontal and vertical direction. Those skilled in the art will appreciate that any known repositioning mechanism that allows the cart 106 to move horizontally and vertically may be employed.

In addition, the apparatus 100 includes a door 118 that switches between an open and a closed position. As shown, the door 118 may be an elongate structure made of any suitable material, such as plastic, metal, or elastomeric material The door 118 may be a sliding door, once opened, allows the cart 106 to move out of the apparatus 100 in the horizontal direction. An actuator, such as a motor, connected to the door 118 enables automatic closing and opening of the door 118. Alternatively, the door 118 may be operated manually.

The apparatus 100 can be associated with any image forming apparatus such as a digital copier, bookmaking machine, facsimile machine, multi-function machine, which performs a print outputting function for any purpose. Moreover, apparatus 100 may perform any number of operations, such as, predetermined punching, stapling, and similar operations, for each medium, such as a sheet, on which an image is formed by the image forming apparatus.

The finisher components, such as the rack 102 and the cart 106 can be made of metal, plastic, or elastomeric materials. A larger assembly, handling corrugated cardboard, for example, would require a more robust construction. It is expected that the elevating mechanism connected to the rack, the reposition mechanism, and/or the door 118 may be controlled by a control system of the finisher, operating through conventional solenoid/controller technology or under computer control. Appropriate limit switches and sensors can signal system status to the finisher control system.

The apparatus 100 allows unload-while-run capabilities where a new load is being stacked while a previous load is awaiting to be offloaded. Moreover, the apparatus 100 elevates the cart 106 to a suitable height, allowing an operator to unload the stack conveniently. The following sections describe a method of using the apparatus 100 to accomplish these capabilities.

FIG. 2 illustrates the apparatus 100 receiving a stack 202 of sheets. As sheets stack to form a load, the rack 102 and the cart 106 index downward in tandem from the loading position (shown in FIG. 1), the cart ribs 108 being located just below the rack ribs 104. The elevating mechanism connected to the rack 102 may control the indexing of the cart with each sheet added onto the stack 202. While sheets are stacked onto the rack 102, the door 118 remains closed. On sensing that a job is complete or the rack 102 is full, the stack 202 is transferred from the rack 102 to the cart 106. Those of skill in the art will understand a number of different methods for determining when a stack 202 is ready to be offloaded. One method exercises control by moving the rack 102 downwards as no sheets are added until an appropriate sensor signals that rack 102 is located at a “full” position. Another method can exercise control by counting sheets, consulting a lookup table to cross-reference the type of sheets being handled with the quantity for a “full” load. Counting systems are also useful in situations where a particular job requires less than a “full” load. For plain copy paper, for example, a “full” stack is about 3,500 sheets. As shown, “full” position refers to a position where rack 102 and cart 106 are lowered to the floor of the apparatus 100 such that the expandable member 116 of cart 106 is in fully compressed state. In other implementations, load transfer may be desired at any position, above the “full” position having the expandable member 116 not fully compressed.

Upon determining that the stack 202 is ready for offloading rack 102, the rack ribs 104 intercalate with the cart ribs 108. As shown, intercalation here refers to a step where cart 106 is controlled such that the rack surface descends to or below the cart surface (or the cart's upper surface). When the rack surface is at the cart surface, the stack 202 is supported by both the rack 102 and cart 106. Subsequently, as the rack 102 descends further, stack 202 effectively shifts to cart 106, as can be seen in FIG. 2. As cart 106 is positioned just below rack 102, the load may be transferred immediately, reducing the time required to offload rack 102. The load transfer may occur with the cart 106 being in fully or partially compressed state. The vertical position of the rack 102 and cart 106 at which the load transfers from one element to another is referred to as the rack transfer position and cart transfer position, respectively. FIG. 2 depicts the cart 106 and rack 102 in their respective rack transfer position and cart transfer position. In an embodiment of the present disclosure, the stack 202 may be transferred from rack 102 to any external device, which may not have ribbed structures for intercalation. In such situation any know load transfer mechanism may be employed that may manually or automatically offload the stack 202 from the rack 102.

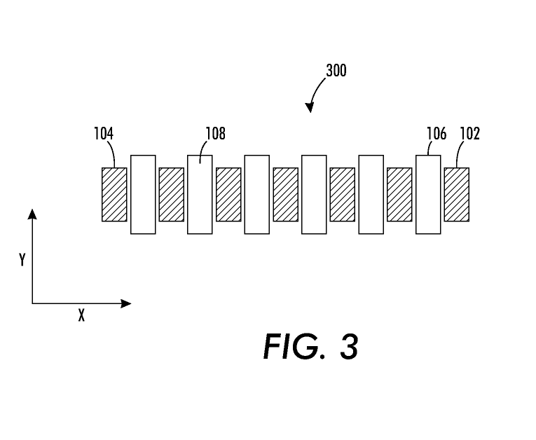

FIG. 3 is a cross-sectional view of the rack 102 and cart 106 in their respective transfer positions, taken on plane Y-Z of FIG. 2. As shown, the rack surface of the rack 102, formed by the upper surfaces of the rack ribs 104, drops below the upper surface of cart ribs 108 (or the cart surface). This allows smooth transition of the stack of sheets (not shown in FIG. 3 for clarity) to the cart 106. Subsequently, when the cart 106 is repositioned, the entire stack 202 is transported with it, avoiding any sheet slippage or drifting. In an alternative embodiment of the system, useful for situations in which the load may be relatively light or the material can slide easily, the rack ribs 104 and cart ribs 108 can lie at the same level, the transfer occurring when the cart 106 is repositioned. Here, the cart surface may have a higher coefficient of friction than the upper surfaces of the rack ribs 104, for ease of transfer. Further, a sensing device identifying the bottom sheet of the stack 202 may be employed for providing confirmation that the entire stack 202 is correctly transferred.

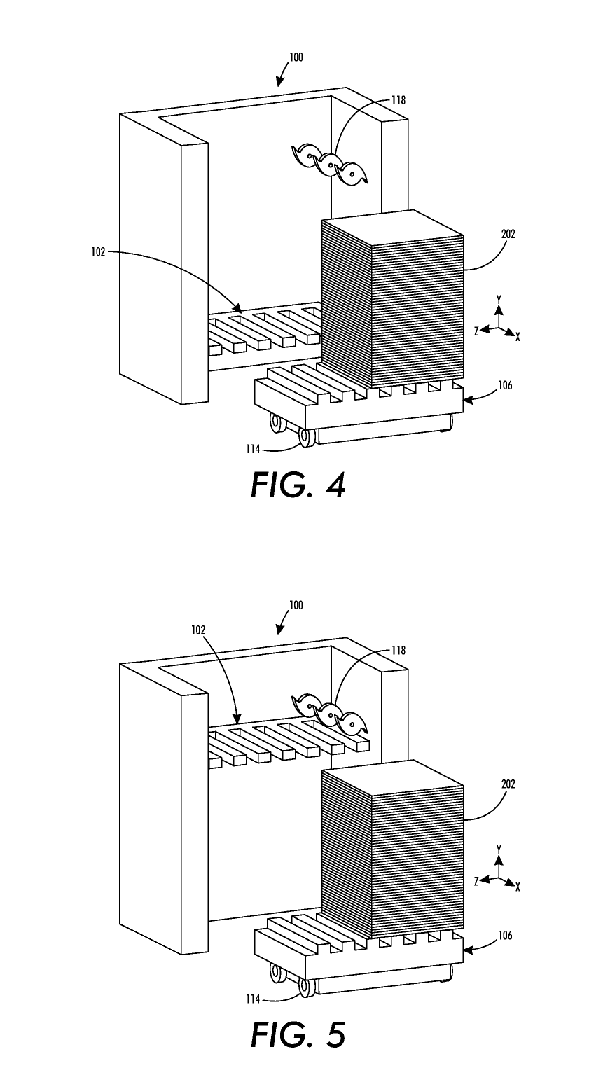

FIG. 4 depicts the cart 106 being displaced horizontally away from the rack 102 to an external position. Once the stack 202 is transferred to the cart, the door 118 on the front of the apparatus 100 opens and the cart 106 traverses horizontally outwards in the X-axis. This horizontally disposed position of the cart 106 represents the external position. Upon a determination that the load is transferred to the cart 106, the door 118 opens automatically, and subsequently, the wheels 114 push the cart 106 outside the apparatus 100 to the external position. To this end, a motor may energize the wheels, and consequently, the cart 106, in the forward direction. As shown, the cart 106 carrying the stack 202 traverses to the external position.

FIG. 5 shows the apparatus 100 in a position to receive a second stack, following the completion of an earlier job. After the cart 106 has exited the apparatus 100 as shown in FIG. 4, the front door 118 closes, and the rack 102, now empty, moves back up to the loading position to start a new job, unattended. The apparatus 100 ensures that the rackl02 is repositioned to the loading position as soon as the cart 106 carrying the stack 202 is displaced to the external position. This feature allows the apparatus 100 to accomplish unload-while-run capability, where the apparatus 100 continuously processes load and as a result, minimizes the apparatus idle time, waiting for an operator to perform unloading. For example, the apparatus 100 begins compiling a second 3,500 sheet stack even if the first has not been cleared (hence referred to as the “unload-while-run”).

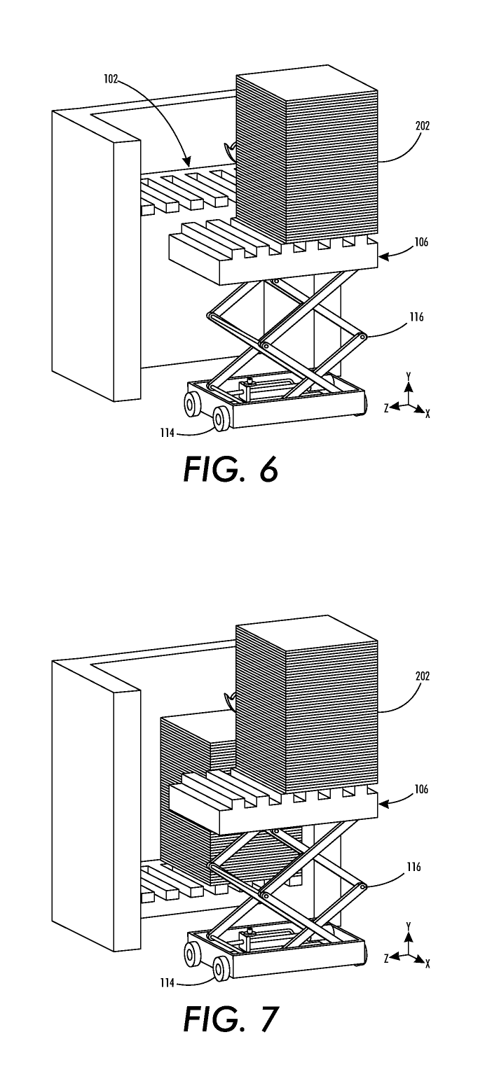

To allow easy off-loading of the stack 202, the apparatus 100 elevates the cart 106 to a substantial height, as seen in FIG. 6, referred to as the unloading position. Moreover, elevating the stack 202 to a suitable height allows an operator to offload conveniently. In an embodiment, the cart 106 may be raised to height of around 25 inches that enables the operator to pick up the load easily, avoiding too much bending. As shown, the expandable member 116 (such as a scissor-lift mechanism) unfolds to increase the height of the unloading position. As the stack is pushed out of the apparatus 100 and elevated, it is visibly apparent to an operator that the output stack needs attention. The operator may collect the stack 202 manually or using a take-away cart.

While the stack 202 waits for the operator to off-load, the new job may continue to load the rack 106, as shown in FIG. 7. The apparatus 100 may continue operation in this situation until the rack 102 drops to the rack transfer position, indicating a stack 702 ready for output. In case the stack 202 is not offloaded before the stack 702 is complete, the apparatus 100 aborts further operation with two full stacks 202,702 ready for off-loading. The apparatus 100, however, facilitates compilation of at least two complete stacks. In an implementation, the apparatus 100 collects up to 7000 sheets before shutting down.

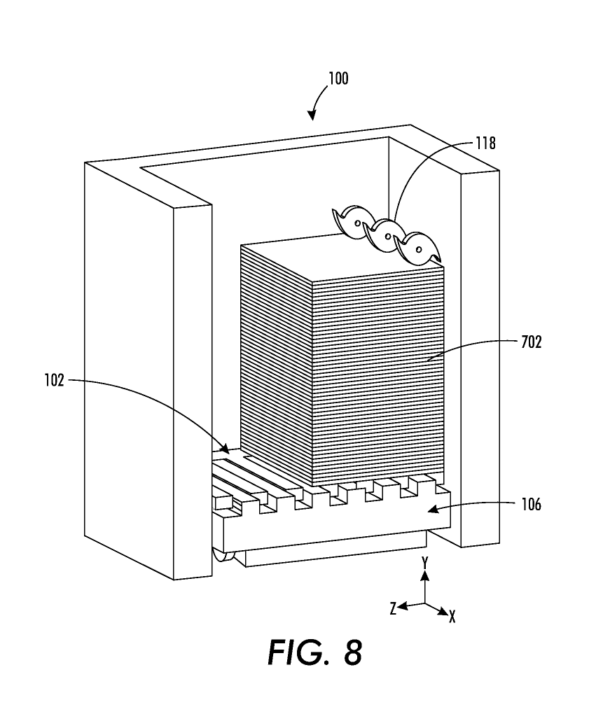

Once the stack 202 is cleared, the cart 106 is repositioned into the apparatus 100, making the cart 106 available for the stack 702, as shown in FIG. 8. The cart 106 may be manually compressed, and pushed back into the apparatus 100. Alternatively, the cart 106 may automatically lower to its fully compress state (external position) and slide back to the cart transfer position, once the stack 202 has been collected.

The apparatus 100 can be associated with any known image forming device dealing with transfer of load, allowing for an unattended unload and subsequent loading of another load. Thus, the apparatus 100 discussed in the present disclosure promotes higher productivity of the image forming device.

The terminology used herein is for the purpose of describing particular embodiments only and is not intended to be limiting of the disclosure. It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for transferring load in a sheet-feeding system, the apparatus comprising:
a rack, vertically movable between a loading position and a rack transfer position, including a plurality of rack ribs, the upper surfaces of the rack ribs defining a rack surface for receiving a stack of sheets; and
a movable cart, positioned beneath the rack, including a plurality of cart ribs, the upper surface of the cart ribs defining an cart surface for receiving the stack from the rack, the cart being configured to move between a cart transfer position, an external position, and an unloading position;
wherein the rack ribs and the cart ribs are positioned to intercalate in the respective rack and cart transfer positions.

2. The apparatus of claim 1 further comprising a door configured to transition between a closed state and an open state, wherein the closed state encloses the cart within the sheet-feeding system, and the open state defines a pathway through which the cart can exit the sheet-feeding system to the external position

3. The apparatus of claim 1 further comprising an elevating mechanism for vertically moving the rack between the rack transfer position and the loading position.

4. The apparatus of claim 1, wherein the cart indexes downward as the rack moves from the unloading position to the rack transfer position.

5. The apparatus of claim 1, wherein the rack surface is at or below the unloading surface during intercalation.

6. The apparatus of claim 1 further comprising a positioning mechanism connected to the cart, the positioning mechanism including a horizontally displacing mechanism and a vertically displacing mechanism.

7. The apparatus of claim 6, wherein the horizontally displacing mechanism moves the cart between the cart transfer position and the external position.

8. The apparatus of claim 6, wherein the vertically displacing mechanism moves the cart between the external position and the unloading position.

9. The apparatus of claim 1, wherein the unloading position is vertically above the external position.

10. The apparatus of claim 1 further comprising a sensing device for sensing whether the stack on the rack needs to be transferred to the cart.

11. A method for transferring a load in a sheet-feeding system, the method comprising:
providing a rack having a plurality of rack ribs, wherein the rack is movable between a loading position and a rack transfer position;
providing a cart having a plurality of cart ribs, wherein the cart is movable between a cart transfer position, an external position, and an unloading position;
receiving a stack of sheets on the rack, the rack being in the loading position;
intercalating the rack ribs in between the cart ribs, the rack and cart being in the respective rack and cart transfer positions, the intercalating includes positioning the rack at or below the level of the cart for transferring the sheets from the rack to the cart;
moving the cart to an external position;
repositioning the rack to the loading position; and
elevating the cart vertically to the unloading position.

12. The method of claim 11, wherein the receiving step includes vertically moving the rack and cart downwards.

13. The method of claim 11, wherein the moving step includes horizontal translation of the cart.

14. The method of claim 13, wherein the moving step includes opening a door to allow horizontal movement of the rack.

15. The method of claim 11, wherein the intercalating step including sensing whether the stack needs to be transferred to the cart.

16. The method of claim 11 further comprising repositioning the rack beneath the cart once the stack is cleared from the unloading position.

17. An apparatus for accepting a stack of sheets in a sheet-feeding system, wherein the sheet feeding system includes a rack, vertically movable between a loading position and a rack transfer position and having a plurality of rack ribs, the upper surfaces of the rack ribs defining a rack surface, the apparatus comprising:
a cart, disposed vertically below the rack, including a plurality of cart ribs, the upper surface of the cart ribs defining a cart surface for receiving the stack of sheets from the rack, the cart being configured to move:
horizontally between a cart transfer position and an external position; and
vertically between the external position and an unloading position;
wherein the rack ribs and the cart ribs are positioned to intercalate in the respective rack and cart transfer positions.

18. The apparatus of claim 17 further comprising a door configured to transition between an open and a closed state, wherein the closed state encloses the cart within the sheet-feeding system, and the open state defines a pathway through which the cart can exit the sheet-feeding system to the external position.

19. The apparatus of claim 17, wherein the rack surface is at or below the cart surface for transferring the stack of sheets.

20. The apparatus of claim 17, wherein the unloading position is vertically above the external position.

21. An apparatus for transferring stack of sheets in a sheet-feeding system, the apparatus comprising:
a vertically movable rack, including a plurality of rack ribs, the upper surface of the rack ribs defining a rack surface for accepting a stack of sheets, the rack being configured to:
index vertically from a loading position to a rack transfer position as the stack of sheets accumulate onto the rack surface;
reposition itself to the loading position once the stack of sheet is transferred to an external device.

22. The apparatus of claim 21, wherein the external device includes ribs.

23. The apparatus of claim 22, wherein the external device ribs and the rack ribs intercalate during stack transfer.

24. The apparatus of claim 21, wherein the external device is positioned vertically beneath the rack.
